(19) United States
(12) Patent Application Publication
(10) Pub. No.: US 2007/0284350 A1
(43) Pub. Date: Dec. 13, 2007

(54) System and Method for Reducing Weld Spatter

(75) Inventors: Scott L. Graham, O'Fallon, MO (US); Rudy A. Holzer, Columbia, TN (US); John F. Gerbic, Franklin, TN (US)

Correspondence Address: GENERAL MOTORS CORPORATION;LEGAL STAFF, MAIL CODE 482-C23-B21, P O BOX 300, DETROIT, MI, 48265-3000, US

(73) Assignee: GM GLOBAL TECHNOLOGY OPERATIONS, INC., Detroit, MI (US)

(21) Appl. No.: 11/423,157

(22) Filed: Jun. 9, 2006

(51) Int. Cl. B23K 9/00

(52) U.S. Cl. 219/137 R; 219/137.43

(57) ABSTRACT

A system and method for reducing the accumulation of weld spatter on welded automotive body panels and the adherence of weld spatter thereto including a compressed air supply, a liquid supply, a pump, at least one control valve, at least one regulator, a controller, and a material handling mechanism. The method includes positioning a body panel with respect to one or more spray nozzle assemblies, applying a controlled spray of anti-spatter liquid to the body panel surfaces prior to spot welding of the panel into a panel assembly, and shutting off the system pressure when the process is complete. The method also includes controlling multiple spray nozzle assemblies using a single pump, and rinsing the panels' surfaces after welding.

### TECHNICAL FIELD

The present invention relates to a system and method for applying anti-spatter liquid to the surfaces of automotive body panels prior to spot-welding of the panels into body panel assemblies for the purpose of reducing the surface adherence of weld spatter on the assemblies.

### BACKGROUND OF THE INVENTION

Welding is the process of fusing or permanently joining the surfaces of two or more metal objects by applying a combination of intense heat and directed pressure at or along a weld joint, typically a point or a series of points along the adjoining surfaces of two or more objects being fused. The intense heat turns the surfaces molten along the length of the weld joint, which when cooled forms a metallurgical bond possessing approximately the same strength properties as the pre-joined individual surfaces. Common industrial fusion processes include arc welding, stick welding, laser welding, and spot welding. Of these, spot welding is uniquely suited for fusing or joining the relatively thin metal sheets that are combined and shaped to form automotive body panels.

During the welding process, droplets of molten metal or “weld spatter” may erupt periodically due to the extreme intensity of heat and force applied at or around the weld joint. The metal surfaces of the objects being welded, or the work surfaces, and the metal surfaces of the welding apparatus itself, such as torch nozzles and peripheral components of the torch, tend to attract errant weld spatter. Weld spatter accumulation can cause undesirable results, which vary depending on the location of the accumulation. For example, weld spatter coating visible surfaces of the work, or the show surfaces, can create an unsightly, rough surface finish, thereby requiring additional time-consuming surface cleaning and weld spatter removal steps. Methods for removing weld spatter include the use of wire brushes, sharp-edged tools, or sandpaper to abrade or pick the weld spatter from the show surfaces. Furthermore, weld spatter adhering to the metal surfaces of weld nozzles can slowly plug nozzle orifices, which may in turn produce poor quality welds and require additional corrective labor. For example, weld spatter build-up on the nozzles may necessitate potentially costly preventive maintenance steps such as frequent weld schedule checks, increased monitoring and adjustment of weld gun tip pressures, and increased frequency of weld cap replacement.

It is known to apply anti-spatter liquid, i.e., a liquid that reduces the propensity of weld spatter to adhere to the external metal tips of welding torches and welding tools in order to impede the build-up of weld spatter. For example, various anti-spatter liquids and solutions are used within automotive MIG welding machines and hand-operated local welding tools in order to keep the torch tips spatter-free, and the machines operating with minimal spatter-related downtime.

It is also known to use protective shields, covers, or masking on and around the exposed work surfaces to act as a barrier to errant weld spatter, thereby preventing molten weld spatter from directly contacting the work. Such masks or shields are typically formed of a suitable heat-resistant material. However, applying, using, and removing masking and shielding can be time, material and labor intensive.

### SUMMARY OF THE INVENTION

The present invention includes an apparatus and method for reducing the accumulation of weld spatter on two or more metal panels being welded, and in particular on the panel surfaces being welded into a vehicle body panel assembly. The method includes pre-positioning a body panel with respect to a spray assembly, and then initiating a control sequence by which anti-spatter liquid is first drawn or pumped from a supply source, delivered to the point of application, and then applied directly by means of a pneumatic spray nozzle to the show surfaces of the vehicle body panels prior to the welding of the panel assembly. Using this method, the applied anti-spatter liquid acts as a barrier to errant molten weld spatter that might otherwise contact and adhere to the show surfaces.

In one embodiment of the method, a materials handling mechanism positions a vehicle body panel with respect to a nozzle or nozzles of an automated pneumatic spray assembly, an integrated controller initiates a sequence by which a pumping system is activated to draw anti-spatter liquid from a supply source or reservoir, a plurality of control valves are actuated, and a plurality of liquid and air lines are thereby pressurized. A spray nozzle or series of spray nozzles then directs a dispersed aerosol spray of anti-spatter liquid, thereby coating or wetting the work surfaces of the vehicle body panels in the assembly to a predetermined thickness. During the spraying process, a material handling mechanism positions and moves the body panel along a predetermined path through the controlled aerosol spray. After all surfaces have been sprayed to the desired level of thickness, the controller then shuts off the air and liquid pressures, and the material handling mechanism transports the prepared body panels to a welding work station.

In another aspect of the method, a controller operatively connected to a single pumping unit controls multiple spray assemblies.

The system of the invention includes air and anti-spatter liquid supplies, a valve operatively connected to the air hoses or lines, a valve operatively connected to the liquid hoses or lines, a spray nozzle for delivering a controlled anti-spatter liquid aerosol spray, a pump operatively connected to the liquid supply, a regulator operatively connected to each of the air and liquid supplies, and a controller operatively connected to the pump and each of the valves for starting, stopping, and controlling the spray process as required.

In another aspect of the invention, the pumping system delivers an independently controlled supply of liquid to a plurality of spray nozzle assemblies for the purpose of running multiple spray processes.

The above features and advantages and other features and advantages of the present invention are readily apparent from the following detailed description of the best modes for carrying out the invention when taken in connection with the accompanying drawings.

### BRIEF DESCRIPTION OF THE DRAWINGS

FIG. 1 is a schematic illustration of the spray system in accordance with this invention; and

FIG. 2 is a pneumatic/hydraulic diagram showing another aspect of the invention in which one pumping unit controls multiple spray nozzle assemblies.

### DESCRIPTION OF THE PREFERRED EMBODIMENTS

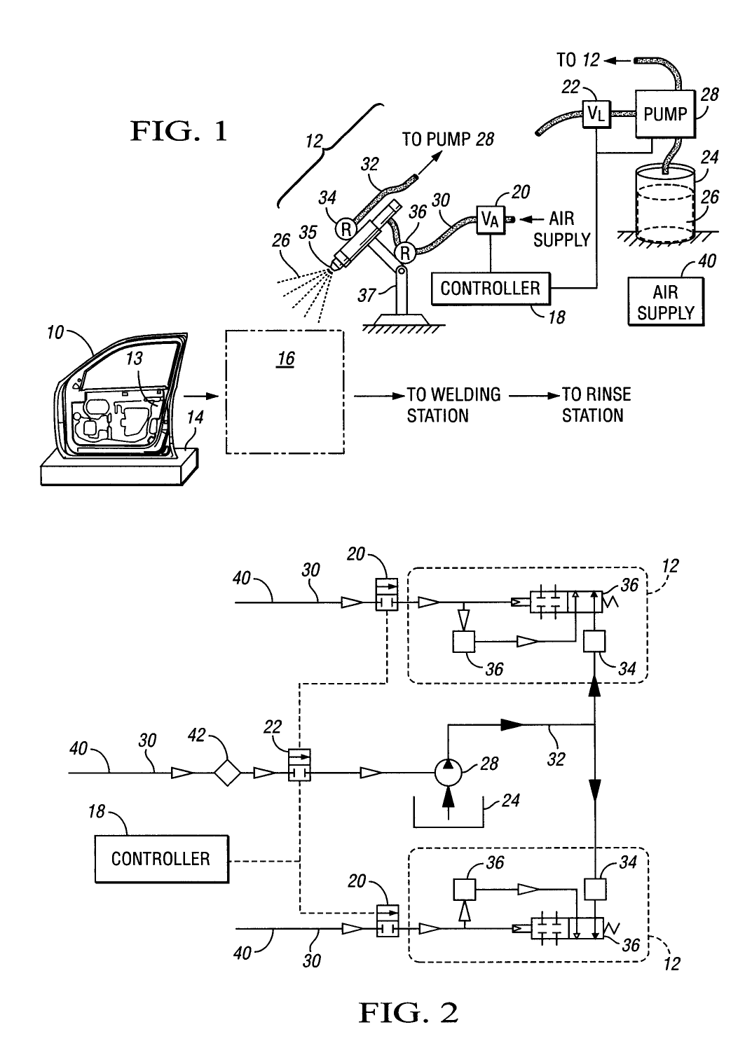

Referring to the drawings, wherein like characters represent the same or corresponding parts through the several views, there is shown in FIG. 1 a schematic illustration of the invention in which a body panel 10 having a panel surface 13 is being transported by means of a material handling apparatus 14 toward a spray nozzle assembly 12. A door is depicted as body panel 10; however, a much more complex panel such as a vehicle body side may also be used with the invention. In the preferred embodiment, material handling apparatus 14 is an automated transport such as a robot, conveyor system, or other automated mechanism of conveyance, although a manually-operated mechanism such as a dolly, manual conveyor or roller bin would also suffice for lower-volume production lines. Spray nozzle assembly 12 as shown has a support post 37 and is fed by liquid supply lines 32 and air supply lines 30, and having at least one spray nozzle 35 disposed at the end of the support post 37, which is preferably pivotable or positionable as shown. For simplicity, air supply 40 is shown to the right in FIG. 1 as a representative box, and may optionally be controlled by the controller 18. Support post 37 could also take the form of an automatically positionable and/or moveable robot arm which is moveable in relation to a body panel 10, which may be fixed or movable relative to the support post 37, with the at least one spray nozzle 35 attached or disposed at the end of the support post 37.

As the body panel 10 approaches a designated spray area 16, controller 18, which may take the form of a Programmable Logic Controller (PLC), Remote Terminal Unit (RTU), Distributed Control Unit (DCU), or similar device, initiates a predetermined spray sequence customized for the size and shape of the body panel 10 being prepared. The controller 18 opens an air supply valve 20 to admit pressurized air into a network of air supply lines 30 from an air supply 40. Air supply 40 preferably includes an air compressor, aftercooler, air dryer, receiver tank and adequate filtration. Air supply lines 30 may be constructed from rubber, metal, plastic, or other suitable material, preferably non-shedding and/or resistant to oxidation so as to prevent downstream particulate contamination.

Pump 28 is operatively connected to an anti-spatter liquid supply 24, preferably a plastic or metal basin or reservoir. In the preferred embodiment, pump 28 is an air-driven, positive displacement pump, although any pump capable of pumping liquid at approximately 40 to 50 pounds-per-square-inch gauge (psig) would be acceptable. The sequence initiated by controller 18 also actuates a liquid supply valve 22 located on a liquid supply line 32 operatively connected to a pump 28, thereby allowing a supply of anti-spatter liquid 26 to be pumped or otherwise drawn from liquid supply 24 by way of pump 28.

Once controller 18 has initiated the spray sequence and actuated valves 20, 22 as specified, a stream of pressurized air is delivered through the air supply lines 30, and a stream of pressurized anti-spatter liquid 26 is delivered through pressurized liquid supply lines 32. Air supply line 30 feeds air to an air pressure regulator 36, and liquid supply line 32 feeds anti-spatter liquid 26 to a liquid pressure regulator 34. In the preferred embodiment, regulators 34, 36 are situated in proximity to the nozzle 35 of spray nozzle system 12 and are pre-set to approximately 2 to 4 psig, allowing the anti-spatter liquid 26 to disperse in aerosol form from the at least one spray nozzle 35 in a fine, controlled pattern. The rate and amount at which anti-spatter liquid 26 is dispersed will vary according to the size and shape of body panel 10, the speed of the manufacturing process, and other factors. Ideally, controller 18 will be set at a spray rate sufficient to coat or wet the desired surfaces of the body panels in the assembly 10 without excessive overspray. Excessive overspray would appear in the form of, for example, drips and runs on the surfaces 13 of body panel 10.

In the preferred embodiment, spray nozzle assembly 12 has a plurality of individual spray nozzles 35, wherein a sufficient number of spray nozzles 35 are present to accommodate the size and shape of the panels in the assemblies being sprayed. The distance between each spray nozzle 35 and the respective surfaces 13 of the body panel 10 being sprayed is preferably approximately 9-12 inches, which at approximately 2 to 4 psig will produce a spray pattern of approximately 6-8 inches in width. The width of the spray path can be readily adjusted by regulating the pressure of regulators 34, 36 and/or the distance between the nozzles 35 and the respective surfaces 13 of the panels in the body panel assembly 10. While any compatible anti-spatter liquid 24 may be properly used with this invention, Wire Wizard™ Blue Magic by Elco Inc. is preferred.

Looking to FIG. 2, a pneumatic/circuit diagram is shown for a spray system delivering a controlled anti-spatter application to multi-product lines. Two spray nozzle assemblies 12 are each shown as a dotted area at the top and bottom of FIG. 2, and represent two separate production lines, for example a door panel for a coupe and a quarter panel for a sedan. The number of product lines can be expanded or reduced by adding additional spray nozzle assemblies 12 as needed. In the preferred embodiment, a single pump 28 and valves 20, 22 are controlled by controller 18 to feed multiple spray assemblies 12. Air supply 40 delivers compressed air through air supply lines 30 to valves 20, 22. A filter 42, preferably a high-efficiency microglass coalescing-style filter, is positioned just before liquid supply valve 22. When valves 20, 22 are actuated, pressurized anti-spatter liquid 26, depicted in FIG. 2 as solid black arrows, is delivered to a plurality of spray nozzle assemblies 12. Once the panel or panels in body panel 10 of FIG. 1 has been coated to the desired level, controller 18 shuts down valves 20, 22, thereby stopping the flow of anti-spatter liquid 26 to the spray nozzle assemblies 12. As shown at the bottom of FIG. 1, the sprayed body panel 10 is then transported to the welding station by way of a material handling apparatus 14 or other suitable means, and the next body panel 10 is positioned as described. After welding, the body panel 10 goes through a spray-rinse process to clean off or remove the oils and residue left from metal stamping. The anti-spatter liquid 26 is also rinsed off of the panel surfaces during this spray-rinse cycle.

While the best modes for carrying out the invention have been described in detail, those familiar with the art to which this invention relates will recognize various alternative designs and embodiments for practicing the invention within the scope of the appended claims.

1. A method of reducing the accumulation of weld spatter on the surface of a weldable vehicle body panel, the method comprising spraying pressurized anti-spatter liquid from a spray nozzle assembly onto said panel prior to welding.

2. The method of claim 1, wherein said body panel is positioned using a material handling robot.

3. The method of claim 1, further including a plurality of liquid supply lines and a plurality of air supply lines, wherein a controller actuates at least one liquid supply valve to pressurize said plurality of liquid supply lines and at least one air supply valve to pressurize said plurality of air supply lines, thereby allowing said liquid to flow to a spray nozzle for coating said surface with said liquid.

4. The method of claim 1 including re-positioning said body panel for a welding process, wherein said welding process is selected from the group: spot welding, arc welding, MIG welding, and MAG welding.

5. The method of claim 3, wherein said liquid and air lines are pressurized to between approximately 2 and 4 psig.

6. The method of claim 3, wherein said coating occurs while positioning said body panel with respect to said spray nozzle assembly along a predetermined path in front of said spray nozzle, and wherein said nozzle discharges a spray pattern being approximately 6-8 inches in width.

7. The method of claim 3, wherein said coating further comprises holding the surface of said body panel stationary and moving said spray nozzle along a predetermined path, thereby coating said surface of said body panel.

8. The method of claim 3, further comprising diverting a portion of said liquid to said spray nozzle, thereby coating said nozzle to minimize accumulation of weld-spatter thereon.

9. The method of claim 3, further comprising rinsing said surface after said surface is welded, whereby to remove said liquid.

10. A method of reducing the accumulation of weld spatter on the show surfaces of a spot-weldable automotive body panel, the method comprising:
positioning said body panel with respect to a spray nozzle assembly;
initiating a controlled anti-spatter liquid system pressure, thereby pressurizing a plurality of anti-spatter liquid lines;
initiating a controlled air pressure, thereby pressurizing a spray nozzle on said spray nozzle assembly and initiating the flow of anti-spatter liquid through said nozzle;
coating said body panel with said anti-spatter liquid at a predetermined spray rate;
shutting off said air system pressure and said anti-spatter liquid system pressure when said body panel has been sprayed to a predetermined coverage; and
re-positioning said body panel for spot welding.

11. A system for applying anti-spatter liquid to the show surfaces of an automotive body panel, the system comprising:
a compressed air supply;
a liquid supply containing anti-spatter liquid;
at least one control valve operatively connected to said air supply;
a first spray nozzle assembly operatively connected to said liquid supply through a pump, wherein said spray nozzle assembly comprises at least one spray nozzle, and wherein said pump is operatively connected to said liquid supply and delivering a pressurized supply of anti-spatter liquid to said first spray nozzle assembly;
at least one compressed air pressure regulator operatively connected to said compressed air supply and said first spray nozzle assembly, and positioned therebetween;
at least one liquid pressure regulator operatively connected to said liquid supply and said first spray nozzle assembly, and positioned therebetween;
a material handling robot for positioning and moving said panel with respect to said first spray nozzle assembly; and
a controller operatively connected to said valve, said first spray nozzle assembly, said air pressure regulator, said liquid pressure regulator, and said robot.

12. The system of claim 11, wherein said air pressure regulator and said liquid pressure regulator are set to approximately 2 to 4 psig.

13. The system of claim 11, wherein said pump is operatively connected to a second spray nozzle assembly comprising at least one additional spray nozzle, for delivering pressurized anti-spatter liquid to said second spray nozzle assembly, and wherein said second spray nozzle assembly is operatively connected to said controller.

14. The system of claim 13, wherein said controller is configured to independently control a plurality of spray nozzle assemblies.

15. The system of claim 13, wherein said pump is operable to pressurize said liquid to between approximately 40 and 50 psig.

16. The system of claim 15, wherein said pump is an air-driven, positive displacement pump.
